(19) United States
(12) Patent Application Publication
(10) Pub. No.: US 2025/0038400 A1
(43) Pub. Date: Jan. 30, 2025

(54) BEAM-STEERING ANTENNA SYSTEMS

(71) Applicants: i5 Technologies, Inc., North Logan, UT (US); Utah State University, Logan, UT (US)

(72) Inventors: Asaduzzaman Towfiq, North Logan, UT (US); Bedri Cetiner, North Logan, UT (US)

(21) Appl. No.: 18/783,084

(22) Filed: Jul. 24, 2024

Related U.S. Application Data
(60) Provisional application No. 63/515,324, filed on Jul. 24, 2023.

(51) Int. Cl. H01Q 1/40; H01Q 1/42; H01Q 5/378

(52) U.S. Cl. CPC H01Q 1/405; H01Q 1/42; H01Q 5/378

(57) ABSTRACT

An apparatus includes one or more antennas; control circuitry coupled to the one or more antennas, the control circuitry configured to drive the antennas to emit radiation; a radome under which the one or more antennas are disposed; and a partially reflective surface (PRS) in or on the radome, the PRS configured to enhance a gain of emission of the radiation by the one or more antennas.

### CROSS-REFERENCE TO RELATED APPLICATION

This application claims the benefit of the filing date of U.S. Provisional Patent Application No. 63/515,324, filed on Jul. 24, 2023, the entirety of which is incorporated herein by reference.

### FIELD OF THE DISCLOSURE

The present disclosure relates to antenna systems, such as antenna arrays.

### BACKGROUND

Phased arrays are used to steer beams of electromagnetic radiation, such as in 5G networks, through constructive and destructive interference of electromagnetic waves. The high cost and high power consumption associated with some phased arrays can make them cost-prohibitive to include in consumer and other devices.

### SUMMARY

Some aspects of this disclosure describe an apparatus including: one or more antennas; control circuitry coupled to the one or more antennas, the control circuitry configured to drive the antennas to emit radiation; a radome under which the one or more antennas are disposed; and a partially reflective surface (PRS) in or on the radome, the PRS configured to enhance a gain of emission of the radiation by the one or more antennas.

This and other apparatuses described herein can have one or more of at least the following characteristics.

In some implementations, the PRS includes an array of metal portions.

In some implementations, the PRS is embedded within the radome.

In some implementations, the PRS is dome-shaped to correspond to a shape of the radome.

In some implementations, the PRS has a spherical cap shape.

In some implementations, the PRS includes: a plurality of controllable components that are controllable to perform phase-shifting on the radiation emitted by the one or more antennas; and a plurality of control inputs of the plurality of controllable components. The control circuitry is configured to deliver control signals to the plurality of control inputs to adjust the phase-shifting.

In some implementations, the control circuitry is configured to adjust the phase-shifting to cause the radiation to have an intensity peak in a target direction.

In some implementations, the control circuitry is configured to adjust the phase-shifting to cause the radiation to have an intensity minimum in a target direction.

In some implementations, a first controllable component of the plurality of controllable components includes an adjustable coupling device.

In some implementations, the adjustable coupling device includes a varactor.

Some aspects of this disclosure describe a method. The method includes: driving one or more antennas to emit radiation, where the one or more antennas are disposed under a radome; and controlling phase-shifting by a partially reflective surface (PRS) in or on the radome, to cause the radiation to have an intensity peak in a target direction.

Some aspects of this disclosure describe another apparatus, the apparatus including: an antenna; a drive input of the antenna; a dome-shaped parasitic layer under which the antenna is disposed, the dome-shaped parasitic layer controllable to perform phase-shifting on radiation emitted by the antenna; one or more control inputs of the dome-shaped parasitic layer; and control circuitry having outputs coupled to the drive input and the one or more control inputs, the control circuitry configured to deliver drive signals to the drive input to drive the antenna to emit the radiation, and deliver control signals to the control inputs of the dome-shaped parasitic layer to adjust the phase-shifting by the dome-shaped parasitic layer.

This and other apparatuses described herein can have one or more of at least the following characteristics.

In some implementations, the dome-shaped parasitic layer has a spherical cap shape.

In some implementations, the control signals are configured to adjust the phase-shifting to cause the radiation to have an intensity peak in a target direction.

In some implementations, the control signals are configured to adjust the phase-shifting to cause the radiation to have an intensity minimum in a target direction.

In some implementations, the dome-shaped parasitic layer includes an adjustable coupling device.

In some implementations, the adjustable coupling device includes a varactor.

In some implementations, the dome-shaped parasitic layer includes a plurality of portions of metal coupled to one another.

In some implementations, the plurality of portions of metal are arranged to receive the control signals.

In some implementations, the apparatus includes a dome-shaped substrate under which the antenna is disposed. The dome-shaped parasitic layer is disposed on a surface of the dome-shaped substrate or in the dome-shaped substrate.

In some implementations, the dome-shaped substrate includes a polymer.

In some implementations, the apparatus includes a radome under which the antenna and the dome-shaped parasitic layer are disposed.

In some implementations, the antenna, the drive input, the dome-shaped parasitic layer, and the one or more control inputs are included in a first reconfigurable emitter of a plurality of reconfigurable emitters. Each reconfigurable emitter of the plurality of reconfigurable emitters includes a respective antenna, a respective drive input of the respective antenna, a respective dome-shaped parasitic layer, and respective one or more control inputs of the respective dome-shape parasitic layer.

In some implementations, the control circuitry includes: a drive module configured to deliver drive signals to the respective drive inputs of the respective antennas of the plurality of reconfigurable emitters, to control respective amplitudes and phases of respective radiation emitted from the respective antennas of the plurality of reconfigurable emitters; a phase-shift module configured to deliver control signals to the respective control inputs of the plurality of reconfigurable emitters; and a joint optimization module configured to jointly determine the drive signals and the control signals to achieve a target objective.

In some implementations, the target objective includes that a beam formed by the respective radiation emitted from the respective antennas of the plurality of reconfigurable emitters has a peak in a target direction and has a minimum in a null direction.

In some implementations, the plurality of reconfigurable emitters are arranged in an array.

Some aspects of this disclosure describe another method. The other method includes: driving one or more antennas to emit radiation, where the one or more antennas are disposed under a dome-shaped parasitic layer; and controlling phase-shifting by the dome-shaped parasitic layer, to cause the radiation to have an intensity peak in a target direction.

The details of one or more implementations are set forth in the accompanying drawings and the description below. Other aspects, features and advantages will be apparent from the description and drawings, and from the claims.

### BRIEF DESCRIPTION OF THE DRAWINGS

FIG. 1 is a diagram illustrating an example of an environment in which a 5G wireless system is deployed.

FIGS. 2 and 3A-3B are diagrams illustrating an example of an antenna system.

FIG. 4 is a diagram illustrating an example of an antenna system.

FIGS. 5A-5B are diagrams illustrating examples of beam-steering strength.

FIG. 6 is a diagram illustrating examples of beam-steering strength.

FIG. 7 is a diagram illustrating an example of a control system.

### DETAILED DESCRIPTION

This disclosure relates to antenna systems incorporating multifunctional and/or reconfigurable elements. In some implementations, the antenna systems include (i) a radome that includes a partially reflective surface (PRS), which can be reconfigurable, (ii) dome-shaped parasitic layer(s) controllable to perform beam-steering on emitted radiation, or both (i) and (ii). These and other characteristics of the systems, devices, and methods described herein can provide higher beam gain and/or improved directivity (e.g., over a wide range of beam-steering angles), improving wireless signal transmission.

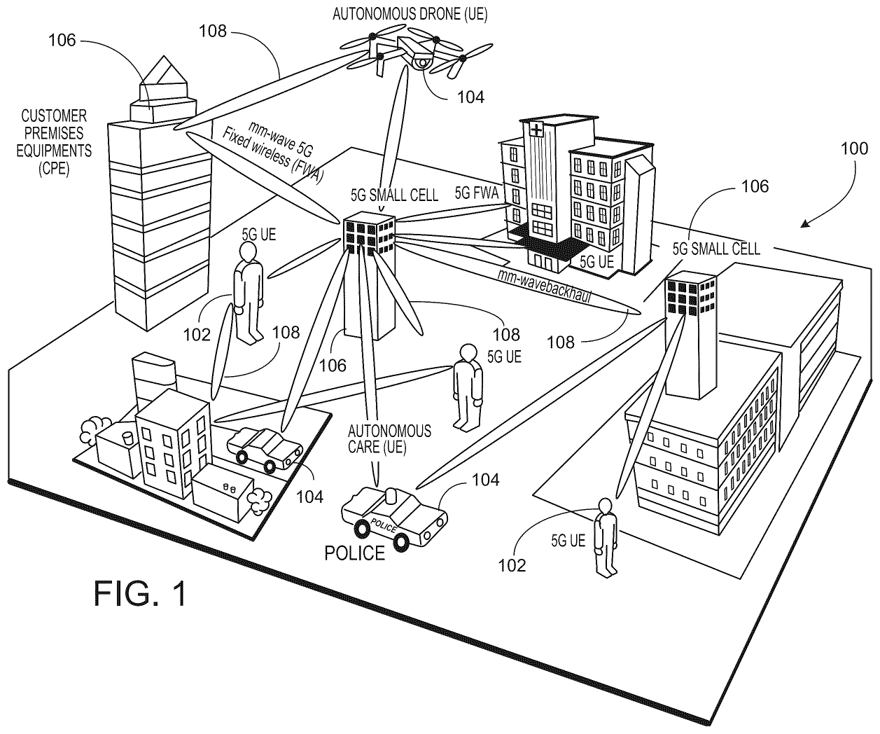

In some millimeter (mm)-wave 5G systems, base stations dynamically steer phased array beams toward intended users to provide improved data rates and to reduce interference for other users, and/or user devices steer their own phased array beams towards base stations. FIG. 1 shows beam-steering in an example of a mm-wave 5G system 100. In such a system, devices 102 of users (e.g., phones, wearable devices, and other personal devices—generally referred to as user equipment (UE)), vehicle-borne devices 104 of vehicles (e.g., antennas of drones and automobiles), and base station antennas and backhaul network components 106 (e.g., in small cells, towers, buildings, and/or infrastructure components) exchange steered radiation beams 108 with one another to send and receive data.

Transmission of steerable beams is not limited to 5G systems but, rather, is also performed in many other types of systems and environments, such as other cellular systems, WiFi transmitters, radio frequency (RF)-based communication systems (e.g., in military and commercial aircraft, spacecraft, and ships), and radar systems. The beams can include various types of radiation, including radio, microwave, and millimeter (mm)-wave. The systems described herein can be configured for operation in any of these and other contexts to provide improved performance metrics, such as gain and directivity, that may be valuable for increasing system efficiency, reducing power consumption, and/or improving data transmission quality.

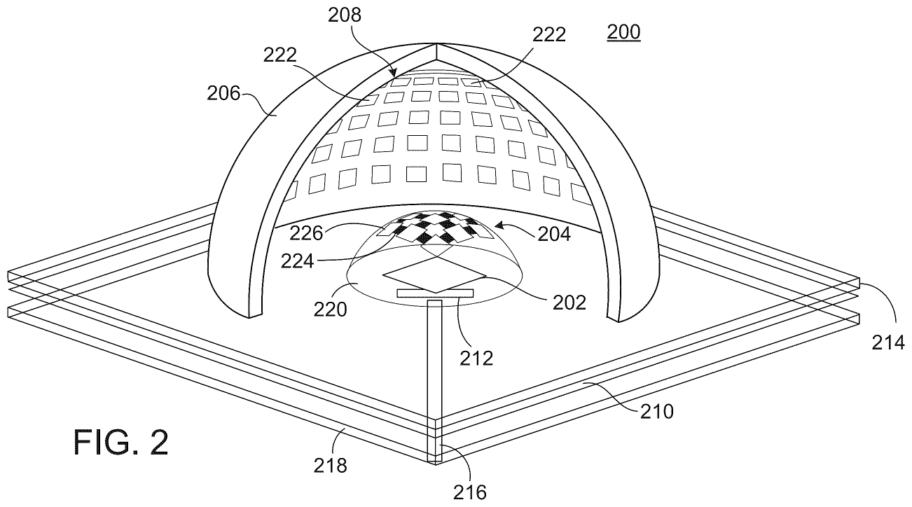

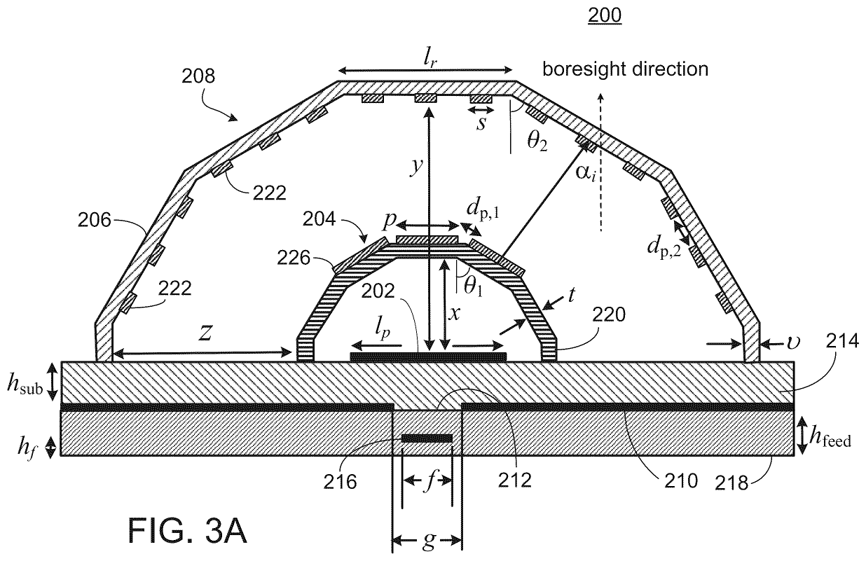

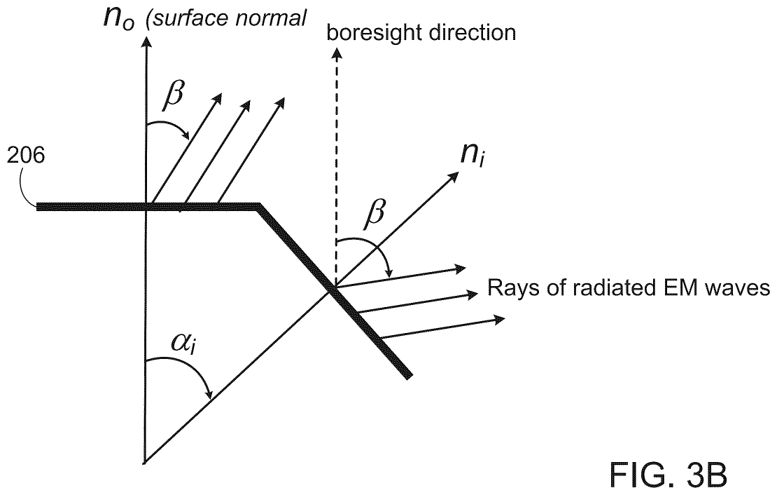

As shown in FIGS. 2 and 3A-3B, an example of an antenna system 200 includes an antenna 202, a radome 206, and a parasitic layer 204. In this example, the radome 206 is a multifunctional radome that hosts a partially reflective surface (PRS) 208, and the parasitic layer 204 is a dome-shaped parasitic layer that is reconfigurable using controllable components of the parasitic layer. However, other implementations are also within the scope of this disclosure, such as antenna systems that include the parasitic layer 204 (or another parasitic layer described herein) without a radome or without a PRS in a radome; antenna systems in which the parasitic layer 204 is not dome-shaped and/or not reconfigurable; and antenna systems that include the radome 206 and integrated PRS 208 without the parasitic layer 204. That is, antenna systems within the scope of this disclosure can include the described radomes with or without the described parasitic layers, and/or can include the described parasitic layers with or without the described radomes, to obtain some or all of the benefits described in reference to the antenna system 200.

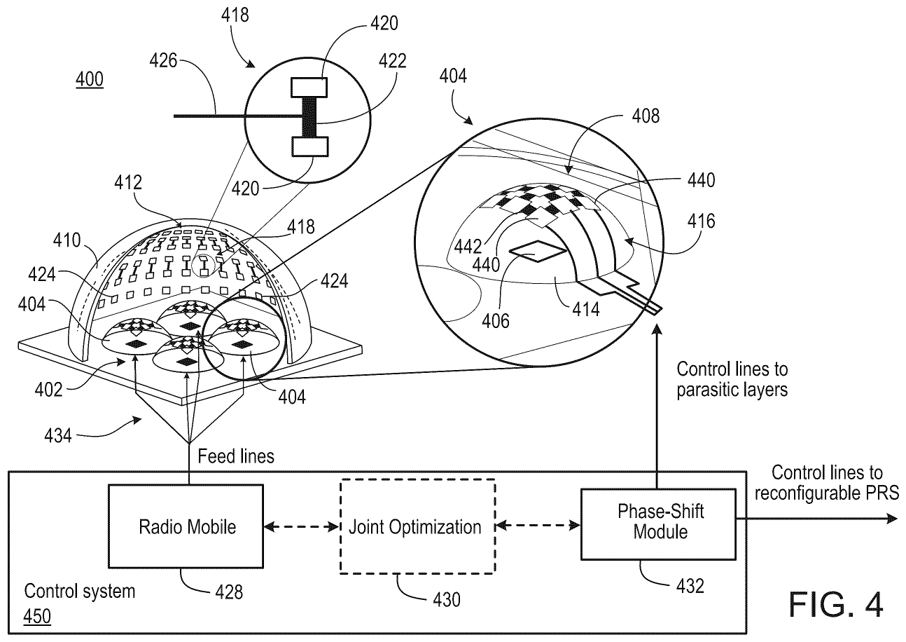

Referring first to the antenna 202, the antenna 202 can be any type of antenna suitable for electromagnetic transmission. In some implementations, the antenna 202 is a patch antenna, e.g., a metal film. For example, as shown in FIGS. 2-3, the antenna 202 is an aperture-coupled patch antenna disposed on and/or in an antenna substrate 214. A microstrip feed line 216, on and/or in a feed substrate 218, couples electromagnetic energy from an antenna driver circuit (e.g., the radio module 428 described with respect to FIG. 4) via a slit 212 in a ground plane 210 between the microstrip feed line 216 and the antenna 202. This coupled electromagnetic energy is emitted as radiation by the antenna 202. In some implementations, other types of feed line can instead or additionally be used, e.g., stripline and/or coplanar waveguide. The substrates 214, 218 can include, for example, printed circuit boards (PCBs). Other types of antenna can instead or additionally be used as the antenna, e.g., dipole antennas, horn antennas, and/or the like.

As shown in FIG. 3A, geometric parameters of the antenna 202 and associated elements include: lₚ, a dimension (e.g., length and/or width) of the antenna 202 (e.g., a dimension of a portion of metal defining a patch antenna); h_{sub}, h_{feed}, and h_{f} are respective thicknesses for the antenna substrate 214, the feed substrate 218, and for a substrate or substrate portion underlying the microstrip feed line 216, respectively; f and g are widths of the microstrip feed line 216 and the slit 212, respectively. In addition, the substrates 214, 218 are characterized by respective dielectric constants. One or more of these parameters can be adjusted/selected for optimization of emission characteristics such as gain and/or directivity, as discussed in further detail below.

In some implementations, the antenna 202, microstrip feed line 216, ground plane 210, and substrates 214, 218 have characteristics as described for the feed lines, patch antennas, and ground planes of FIGS. 8, 10-12, and/or 15 of U.S. Patent Application Publication No. 2021/0151877, incorporated by reference herein in its entirety. Other antenna implementations (e.g., having multiple feed lines per antenna patch, having different arrangements of substrates, feed lines, and/or ground planes, etc.) are also within the scope of this disclosure.

In reference next to the radome 206, the radome 206 is a protective structure under which the antenna 202 is disposed. The radome 206 can be composed of material(s) that protect the underlying antenna 202 while not interfering, or interfering relatively little, with radiation (e.g., radio waves) emitted by the antenna 202. For example, the radome 206 can be composed substantially of fiberglass, a plastic/polymer such as polytetrafluoroethylene (PTFE) and/or polyurethane (e.g., polyurethane foam), fabric, or a combination of these materials, such as PTFE-coated fabric. In some implementations, the radome 206 is composed of one or more high-quality dielectrics, e.g., having a dielectric constant of approximately 3 and/or having a loss tangent of less than 0.002, for radiation (e.g., radio waves) emitted by the antenna 202. The radome 206 can be substantially transparent to radio waves so as to permit penetration and external transmission of emitted radio waves. The radome 206 can have various shapes, such as spherical, geodesic dome (e.g., based on a geodesic polyhedron), planar, and/or other curved regular or irregular shapes. When the radome 206 is a dome under which the antenna 202 is disposed, as in the example of FIG. 2, the dome can be a spherical cap (e.g., a full sphere, a half-sphere, or another spherical portion) or can be non-spherical, e.g., an ellipsoid or an irregularly-curved dome. As used herein, “dome” and “dome-shaped” refer not only to smooth domes but also to polygon-based shapes such as geodesic polyhedra that approximate smooth domes.

The partially reflective surface (PRS) 208 is in and/or on the radome 206 and renders the radome 206 a “multifunctional” component. For example, the PRS 208 can be embedded entirely within the radome 206 and/or exposed on inner and/or outer surface(s) of the radome 206. The PRS 208 is configured to reflect some, but not all, radiation emitted by the antenna 202, trapping emitted electromagnetic waves inside the cavity defined by the radome 206. For example, in some implementations, the PRS 208 is formed of multiple conducting pixels 222 (sometimes referred to as patches), e.g., square pixels, rounded pixels, and/or strips. Gaps between the reflective pixels 222 render the PRS “partially” reflective. The pixels 222 can be evenly spaced (e.g., in an array) and/or unevenly spaced. The pixels 222 can be composed of one or more materials that reflect radiation emitted by the antenna 202. For example, the pixels 222 can be composed of one or more metals. In some implementations, at least some of the pixels 222 are reconfigurable pixels, e.g., as described in reference to FIG. 4. In some implementations, the pixels 222 are metal films disposed on and/or in the radome 206. Instead of, or in addition to, metal, the pixels 222 can be composed of one or more other material types, such as phase change materials, dielectric materials with varying dielectric constant (e.g., at least some of the pixels 222 can have different dielectric properties from one another) conductive polymers, etc.

The PRS 208 is in and/or on the radome 206 such that the overall shape of the PRS 208 (e.g., the shape generally defined collectively by the pixels 222), follows the shape of the radome 206. For example, the PRS 208 can be dome-shaped to correspond to a shape of the radome 206. For example, the PRS 208 can have a spherical cap shape Raover the antenna 202.

The PRS 208 is configured to enhance directivity and/or gain for emission by the antenna 202. Specifically, electromagnetic waves trapped in the cavity of the radome 206/PRS 208 undergo multiple reflections inside the cavity and eventually are partially transmitted through the radome 206 and PRS 208 with higher gain and/or directivity than in the absence of the PRS 208. In some implementations, based on the radome integration of the PRS 208 (e.g., based on the PRS 208 having a dome shape), the PRS 208 can enhance gain and/or directivity across a range of emission directions, e.g., in all emission directions. For example, the gain can be enhanced by a value Gₑᵢ having the following expression:

$${G}_{ei} = \frac{1 - {{R}_{i}}^{2}}{1 + {{R}_{i}}^{2} - 2 {{R}_{i}}^{2} cos [ {φ}_{i} - π - \frac{4 π {d}_{i}}{λ} cos ( {α}_{i} ) ]}$$

where Gₑᵢ is the enhanced gain value in the direction of maximum radiation peak of emitted electromagnetic radiation for a given beam steering direction i; Rᵢ and φᵢ are the magnitude and phase, respectively, of the reflection coefficient of the PRS 208 for αᵢ; αᵢ is the steering angle in the direction of surface normal nᵢ, where the surface normal no shown in FIG. 3B corresponds to the boresight direction (e.g., αᵢ can be the angle between the boresight direction n₀ and the surface normal of a segment of the radome 206 corresponding to the steering angle αᵢ, such as in the case of a spherical radome 206 centered on the antenna 202); A is the wavelength of the emitted radiation in free space; and di is the distance along the direction of maximum radiation peak between a ground plane of the antenna 202 and the radome 206. dᵢ=yᵢ+h_{sub} as shown in FIG. 3A, where yᵢ is the distance between the PRS 208 and the antenna 202 (shown in FIG. 3A for the boresight direction). As shown in FIG. 3B for a portion of the radome 206, β is the angle between the boresight direction and the angle of radiated EM waves.
Gₑᵢ can be optimized (e.g., using full-wave electromagnetic analyses and RF/microwave design tools) by optimizing the reflectivity of the PRS 208 (e.g., Rᵢ and/or φᵢ), and/or other parameters shown in FIGS. 3A-3B, such as geometric parameters, for a range of steering angles αᵢ to enhance the gain and/or directivity of the antenna system 200 over a target beam-steering range, e.g., over a range of beam-steering directions of at least 45°, at least 90°, or at least 180°. β does not appear in the Gₑᵢ relationship above, signifying that the systems described herein can provide gain improvement over a wide beam steering range. Conceptually, in some implementations, this enhancement is related to curved/dome-shaped (e.g., spherical) shape of the PRS 208, permitting the PRS 208 to act uniformly across the steering range. In contrast, some other systems that include a non-radome-integrated PRS for gain enhancement may not achieve gain enhancement over an appreciable steering range, or may achieve less gain enhancement over an appreciable steering range, based on the non-radome-integrated PRS.

As shown in FIG. 3A, geometric parameters of the radome 206 with integrated PRS 208 include: s, a dimension (e.g., length and/or width) of the pixels 222; θ₂, an angle of curvature of the PRS 208/radome 206; y, a radius of the PRS 208/radome 206 (in this example, the distance between the PRS 208 and the antenna 202); v, a thickness of the radome 206; 1r, a segment length of the radome 206 (e.g., a geodesic segment dimension); a dielectric constant of the radome 206; and d_{p,2}, a distance between pixels 222. In the case where the radome 206/PRS 208 is non-spherical, y can be another dimension of the One or more of these parameters can be adjusted (in some implementations in concert with parameters of the antenna 202, underlying layers, and/or the parasitic layer 204) to increase Gₑᵢ (e.g., by optimizing R and/or φ) across a desired range of steering directions for radiation emitted by the antenna 202. In some implementations, y is approximately a half-wavelength distance, e.g., λ/2. For example, in some implementations, y is less than 100 mm, less than 200 mm, or less than 500 mm; other values for y are also within the scope of this disclosure. These geometric parameters are non-limiting examples—for example, θ₂ can be understood as generally relating to a shape of the PRS 208/radome 206, which can be varying for different portions of the PRS 208/radome 206.

Referring now to the parasitic layer 204 illustrated in FIGS. 2 and 3A, the parasitic layer 204 is dome-shaped and overlies the antenna 202. For example, the parasitic layer 204 can have any of the shapes described in reference to the PRS 208, e.g., a spherical or non-spherical cap shape. The shape of the parasitic layer 204 is an overall shape, e.g., as defined collectively by elements (such as pixels and/or controllable components) of the parasitic layer 204.

The parasitic layer 204 is configured to perform phase-shifting on radiation emitted by the antenna 202. For example, the parasitic layer 204 can be configured to perform space-wave phase-shifting on already-emitted radiation, as contrasted from guided-wave phase-shifting that is performed on signals in transmission lines. In the context of an array of antennas and corresponding parasitic layers (e.g., as discussed in reference to FIG. 4), this phase-shifting can be used to steer the radiation, e.g., to cause the radiation to have an intensity peak in a target direction and/or an intensity minimum in a target direction. Moreover, even on the level of a single antenna as shown in FIGS. 2 and 3A, the parasitic layer 204 can impart a degree of directivity to the beam, e.g., as reflected in the indicated steering angle αᵢ.

The parasitic layer 204 includes pixels 226 and one or more adjustable coupling devices 224 between the pixels 226 that together facilitate modulation/adjustment of the phase-shifting by the parasitic layer 204. Specifically, radiation emitted by the antenna 202 couples electromagnetically with the parasitic layer 204 and induces an RF current in the parasitic layer 204 that depends on the complex impedance of the parasitic layer 204. The adjustable coupling devices 224 are controllable (e.g., using control inputs, as described in reference to FIG. 4) to adjust couplings (e.g., inductive and/or capacitive couplings) between the pixels 226 to adjust the complex impedance and thereby tune the level of the phase-shift. Adjusting the complex impedance can correspond to adjusting the effective shape (e.g., length) of the parasitic layer 204 by switching on/off couplings between pixels 226 and/or by adjusting the strength(s) of couplings between pixels 226.

The pixels 226 can include portions of conductive material, e.g., metal films. The adjustable coupling devices 224 can include switching elements such as diodes, varactors, and/or microelectromechanical systems (MEMS) that can be controlled by input signals to vary coupling(s) between the pixels 226. For example, in some implementations, the parasitic layer 204 can have characteristics as described for the combination of “metallic strips” and “switch elements 118” of U.S. Patent Application Publication No. 2021/0151877 and/or as described for the “controllable components” of U.S. Patent Application Publication No. 2023/0142988, each of which is incorporated by reference herein in its entirety. For example, the parasitic layer 204 can have an arrangement of pixels 226 and adjustable coupling devices 224 as shown in FIGS. 13 and/or 15-21 of U.S. Patent Application Publication No. 2021/0151877 and/or FIGS. 4, 6, 7, and/or 15A-15C of U.S. Patent Application Publication No. 2023/0142988.

The pixels 226 and the adjustable coupling devices 224 are provided in and/or on a dome-shaped substrate 220 that defines the dome shape of the parasitic layers 204. For example, the pixels 226 and the adjustable coupling devices 224 can be exposed on a surface of the dome-shaped substrate 220 (e.g., an inner and/or outer surface) and/or embedded in the dome-shaped substrate 220. The dome-shaped substrate 220 can be composed of one or more dielectric materials as described for the radome 206, e.g., a polymer or plastic.

Based on the dome shape of the parasitic layer 204, the parasitic layer 204 can, in some implementations, provide improved uniformity in phase adjustment over an entire electromagnetic wave emitted by the antenna 202, thereby providing improved gain and/or directivity in radiation emitted by the antenna system 200 as a whole. Radiation emitted by the antenna 202 has an approximately spherical wavefront in the near-field, and the dome-shaped parasitic layer 204 has a shape that matches or approximately matches this wavefront, e.g., compared to a planar, non-dome-shaped parasitic layer.

Accordingly, the radiation can be uniformly phase-shifted across the wavefront by interaction with the parasitic layer 204, resulting in improved beam-steering (e.g., gain and/or directivity) for radiation emitted from one antenna or a collection of antennas in an array, e.g., as described in reference to FIG. 4.

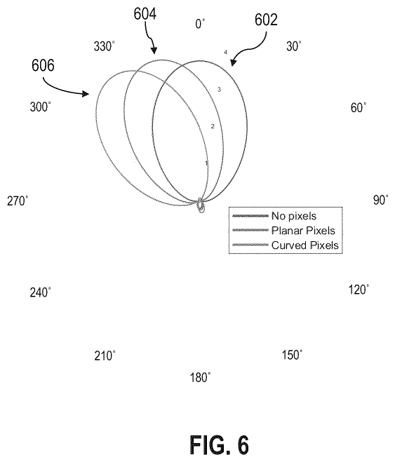

For example, FIG. 6A illustrates simulated broad-side beams for emission by (i) an antenna without configurable pixels (e.g., a legacy patch antenna) (602), (ii) an antenna paired with a planar set of configurable pixels (e.g., a planar parasitic layer) (604), and (iii) an antenna paired with a curved/dome-shaped parasitic layer 204 (606).

The third system exhibits significantly-improved beam-steering range and gain. for example, the legacy patch antenna has fixed radiation properties with a typical gain of 5 dB. The antenna with the planar reconfigurable parasitic layer may provide dynamic beam-steering in multiple planes with a typical gain of about 7 dB over a field of about 60°. The use of the dome shaped parasitic layer can provide (i) improvement in gain for an individual antenna under the parasitic layer, e.g., gain of at least 7 dB, 8 dB, or at least 9 dB, and (ii) improvement in beam-steering range, e.g., to at least 80°, at least 90°, or at least 100°. For example, the gain of at least 7 dB, 8 dB, or at least 9 dB can be provided over the entire range of at least 80°, at least 90°, or at least 100°. Moreover, when individual reconfigurable antenna elements are combined into an array and provided under a radome-integrated PRS as described in reference to FIG. 4, the system as a whole can, in some implementations, provide at least 12 dB, at least 13 dB, or at least 14 dB over an entire range of at least 80°, at least 90°, or at least 100°.

As shown in FIG. 3A, the parasitic layer 204 and corresponding dome-shaped substrate 220 can be defined by one or more parameters that can be selected to improve the uniformity and adjustability of the phase-shift provided by the parasitic layer 204, and/or to improve the gain of emission (e.g., to enhance the gain over a considerable angular range). Non-limiting examples of the parameters include: p, a dimension (e.g., length) of the pixels 226; z, a distance between the substrate 220 and the radome 206; x, a radius of the parasitic layer 204/substrate 220; t, a thickness of the substrate 220; θ₁, an angle of curvature of the parasitic layer 204/substrate 220; and d_{p,1}, a distance between pixels 226. In some implementations, x is a small fraction of the wavelength λ, e.g., less than 0.05λ. Moreover, electro-optical aspects of the parasitic layer, such as type(s) and number of the adjustable coupling devices 224 (e.g., to set a degree of capacitive coupling between pixels 226) and/or a dielectric constant of the substrate 220 can instead or additionally be selected to obtain uniform and tunable phase-shifts.

Although FIGS. 2 and 3A show a single antenna 202 under the radome 206 with integrated PRS 208, in some implementations multiple antennas can be disposed under a radome, the multiple antennas forming an array. The multiple antennas can optionally be disposed under respective dome-shaped parasitic layers as described for the antenna 202 and dome-shaped parasitic layer 204, and/or a PRS (e.g., a dome-shaped PRS) can optionally be integrated together with the radome, as described for the radome 206 and PRS 208.

For example, as shown in FIG. 4, an antenna system 400 includes an array 402 of multiple reconfigurable emitters 404. Each reconfigurable emitter 404 includes a corresponding dome-shaped parasitic layer 408 and an antenna 406 under the dome-shaped parasitic layer 408. The array 402 is under a radome 410 having an integrated PRS 412 in and/or on the radome 410. Except where indicated otherwise, the reconfigurable emitters 404 can have characteristics as described for the antenna 202 and parasitic layer 204 with respect to FIGS. 2 and 3A-3B. For example, the antennas 406 can be patch antennas disposed on a common substrate and coupled to feed lines through respective apertures in a ground plane (not shown). Except where indicated otherwise, the radome 410 and PRS 412 can have characteristics as described for the radome 206 and PRS 208. For example, as discussed in further detail below, in this example the PRS 412 is a reconfigurable PRS including adjustably-coupled pixels; however, within the scope of this disclosure, a radome-integrated PRS above an array of (optionally-reconfigurable) emitters need not be reconfigurable.

The array 402 can include various numbers of reconfigurable emitters 404, in various patterns. For example, the array can include several, tens, hundreds, or thousands of reconfigurable emitters 404, and the reconfigurable emitters 404 can be arranged in a regular array (e.g., with regular rows/columns) and/or in a spatially-varying array, e.g., with spatially-varying separation between reconfigurable emitters 404.

Based on the adjustability of the reconfigurable emitters 404, radiation emitted by the antenna system 400 can exhibit high gain across a wide range of steering angles (equivalently, low scan loss) and high directivity. In general, the emission characteristics of a phased antenna array (PAA) can be formulated as Array Pattern (AP)=Element Factor (EF)×Array Factor (AF), where EF describes the properties of individual antenna elements (e.g., radiation pattern, polarization, and frequency) and AF describes the pattern of the array in the case where each antenna element is replaced by an isotropic antenna coupled to a common current source. In traditional array design, EF is fixed, and AF (and thus AP) is controlled only by adjusting beamforming weights (e.g., phase and/or amplitude) of currents provided to each antenna element. This may result in high scan loss as emitted beams are steered away from broadside. Moreover, signal processing algorithms may be limited to optimizing only the element-wise weights, which may limit system flexibility. However, when the antenna elements are reconfigurable as described herein for the reconfigurable emitters 404, AP is jointly controlled by both EF and AF. This joint optimization can, in some implementations, reduce scan loss associated with PAAs, resulting in improved gain (e.g., 3-5 dB more gain in some implementations) compared to a traditional PAA over the full beam-steering range. In addition, an additional degree of freedom is provided by the reconfigurable emitters 404, introducing new opportunities for system optimization and beamforming based on jointly-optimized software and/or hardware. This can result in, for example, improved directivity, such as lower power transmitted to beam nulls, and/or overall improved emission flexibility, e.g., complex wave-shapes to provided targeted beam transmission to multiple receiving devices.

As shown in FIG. 4, each reconfigurable emitter 404 includes an antenna 406 and a dome-shaped parasitic layer 408 provided in and/or on a substrate 414. As discussed in reference to FIGS. 2 and 3A-3B, the parasitic layer 408 includes multiple pixels 440 and one or more adjustable coupling devices 442, such as varactors. In some implementations, the pixels 440 and adjustable coupling devices 442 have characteristics as described for the pixels 226 and adjustable coupling devices 224, respectively. The substrate 414 can have characteristics as described for the substrate 220.

In addition, in this example, the PRS 412 includes multiple reconfigurable elements 418 (sometimes referred to as “controllable components”). Each reconfigurable element 418 includes multiple pixels 420 and one or more adjustable coupling devices 422 coupling the pixels 420 (in this example, two pixels 420 coupled by a single adjustable coupling device 422). The pixels 420 can have characteristics as described for the pixels 222, e.g., can include metal films in and/or on the radome 410. The adjustable coupling devices 422 can also be disposed in and/or on the radome 410 (e.g., on an inner surface of the radome 410, on an outer surface of the radome 410, and/or embedded within the radome 410), and can include one or more types of coupling device, such as a varactor. The pixels 420 and adjustable coupling devices 422 can be coupled together in various arrangements, as described for the pixels 226 and adjustable coupling devices 224. Accordingly, the complex impedance of each reconfigurable element 418 can be adjusted to cause the PRS 412 to perform beam-steering, e.g., to cause emitted radiation to have intensity peaks and/or minima in target direction(s). The beam-steering by the PRS 412 can be joint beam-steering together with steering provided by the parasitic layers 408.

In some implementations, not all elements of a reconfigurable PRS are reconfigurable. For example, the PRS 412 includes pixels 424 that are not coupled to an adjustable coupling device and that have static complex impedance. In some implementations, all elements of a PRS are reconfigurable.

A control system 450 (e.g., control circuitry) can be configured to provide signals to the reconfigurable emitters 404 and the PRS 412 to (i) drive the antennas 406, (ii) adjust phase-shifting by the parasitic layers 408, and (iii) adjust phase-shifting by the PRS 412. For example, the control system 450 can include one or more computing devices, which can be local to the antennas and/or remote.

In some implementations, as shown in FIG. 4, the control system 450 includes a radio module 428 (sometimes referred to as a “drive module” or “radio control circuitry”), a joint optimization module 430, and a phase-shift module 432 (sometimes referred to as “DC control circuitry”). The modules 428, 430, 432 can be hardware and/or software modules, and need not be distinct elements but, rather, can be combined with one another and/or with other modules as combined computing and/or circuitry/hardware elements.

The radio module 428 is configured to provide RF signals (sometimes referred to as “drive signals”) to the antennas 406, to drive the antennas 406 to emit radiation. For example, the RF signals can encode data for transmission by the antenna system 400 to one or more other devices. The RF signals can be provided via feed lines 434 that are coupled to respective drive inputs of the antennas 406. The feed lines 434 can be referred to as “drive inputs,” because input signals to drive the antennas 406 are provided through the feed lines 434. In some implementations, the feed lines have characteristics as described for the microstrip feed line 216 illustrated in FIGS. 2 and 3A. Based on the amplitudes and/or phases of the drive signals, radiation emitted by each antenna 406 has a respective amplitude and/or phase corresponding to a target beam profile. In a legacy antenna system, the only control is control provided to the antennas (array factor control).

The phase-shift module 432 is configured to adjust adjustable coupling devices 442 and/or 422 in the PRS 412 and/or the parasitic layers 408. For example, the phase-shift module 432 can provide control signals (e.g., DC control signals) via control lines 416 to the parasitic layers 408 and/or via control lines 426 to the PRS 412. The control signals switch the adjustable coupling devices 442 and/or 422 on/off and/or adjust a degree of coupling of the adjustable coupling devices 442 and/or 422. For example, the control signals can adjust voltages over varactors (as the adjustable coupling devices) to adjust capacitances of the varactors. In some implementations, the control lines 416 and/or 426 are connected directly to pixels 440 and/or 420, as shown in the inset of the reconfigurable emitter 404 in FIG. 4. In some implementations, the control lines 416 and/or 426 are connected directly to the adjustable coupling devices 442 and/or 422. The control lines 416 and/or 426 can be referred to as “control inputs,” because control signals to adjust the complex impedances of the parasitic layers 408 and/or reconfigurable elements 418 are provided through the control lines 416 and/or 426.

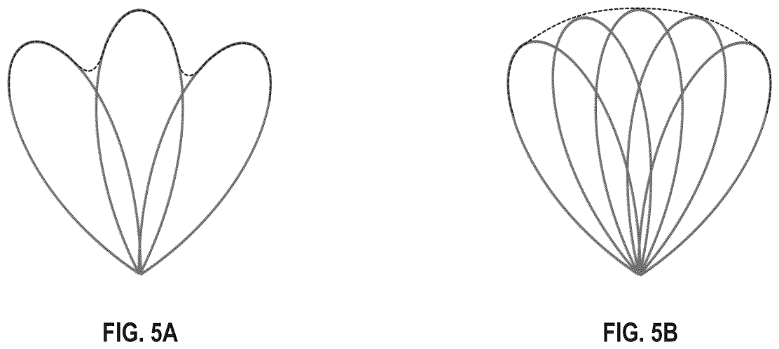

In some implementations, the control system 450 is configured to control the varactors in a non-binary manner, e.g., to control at least one of the varactors between at least three different values. For example, the varactors can be controlled continuously or quasi-continuously (e.g., within a signal generation precision of the control system 450). This control can permit more-optimal tuning of the adjustable coupling devices 442 and/or 422, to provide constant or near-constant gain over an entire beam-steering range. For example, FIG. 5A illustrates simulated beam-steering strength over an angular range using binary switches, and FIG. 5B illustrates simulated beam-steering strength over the same angular range using varactor coupling elements. The binary switch-based system has significantly reduced gain at certain angles, whereas the varactor-based system has nearly constant gain over the whole range.

Besides the advantages associated with gain, in some cases, varactors can be manufactured at low cost and exhibit almost negligible power consumption, reducing system cost and power consumption compared to some alternative devices.

As shown in FIG. 4, the control lines can be integrated into the substrates that define the dome-shaped parasitic layers and/or into the radome. For example, the control lines 426 can be provided in and/or on the radome 410 to couple to the reconfigurable elements 418, and/or the control lines 416 can be provided in and/or on the substrates 414 to couple to the parasitic layers 408. Accordingly, in some implementations, the control lines 426 and/or 416 can have a curved shape defined by the dome shapes of the radome 410 and/or substrates 414.

In some implementations, the drive signals and the control signals are determined in a joint optimization process performed by the joint optimization module 430. The joint optimization module 430 can be configured to perform beamforming calculations in which both the array factors (AF) are controlled by adjustment of the drive signals (by the radio module 428), and the element factors (EF) are controlled by adjustment of the control signals to adjust complex impedances of the parasitic layers 408 (by the phase-shift module 432). In implementations that include the reconfigurable elements 418 in the PRS 412, the joint optimization can further include adjustment of the complex impedances of the reconfigurable elements 418. The joint optimization process based on these multiple parameters can result in highly flexible and powerful beam-steering, with very high gain for intensity peaks in target directions, and/or very low emitted power (nulls) in other target directions. In some implementations, the joint optimization module 430 is configured to implement a full-wave electromagnetic analysis (e.g., a simulation) to identify, for example, a combination of drive signals and control signals that provided beam intensity peaks and/or nulls in target direction(s).

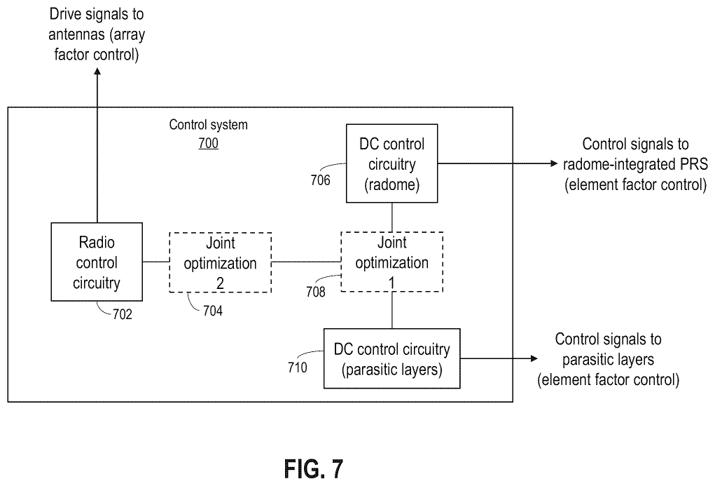

Joint optimization can take place various orders. For example, as shown in FIG. 7, in some implementations the control system 700 (having characteristics as described for the control system 450, except where noted otherwise or suggested otherwise by context) is configured to perform optimization in two stages. In a first stage, DC control circuitry 706 that provides control signals to radome-integrated PRS and DC control circuitry 710 that provides control signals to reconfigurable parasitic layers (e.g., dome-shaped parasitic layers under which antennas are provided) are controlled in a joint optimization process by a first optimization module 708, which relates to element factor control. In a second stage, the controls of the first optimization are jointly optimized with radio control circuitry 702 (which provides drive signals to antennas for array factor control) by a second joint optimization module 704. As another example, the array factor control can first be jointly optimized with the element factor of the parasitic layers, which can then be jointly optimized with the element factor of the radome-integrated PRS. As another example, the array factor control cab first be jointly optimized with the element factor of the radome-integrated PRS, which can then be jointly optimized with the element factor of the parasitic layers.

In some implementations, beam-steering is performed entirely based on control of the parasitic layers 408 and/or reconfigurable elements 418. For example, guided-wave phase-shifting may be absent, such that the antennas 406 of the array receive in-phase or almost in-phase signals, and the phase-shifting to steer emitted radiation is entirely or almost entirely space-wave phase-shifting by the dome-shaped parasitic layers and/or the reconfigurable PRS. In some implementations, this can reduce energy consumption and/or dissipation that would otherwise be associated with guided-wave phase-shifting, improving the energy efficiency and/or thermal characteristics of the antenna system.

As noted above, although the antenna system 400 of FIG. 4 includes both dome-shaped parasitic layers and a reconfigurable, radome-integrated PRS, in some implementations an antenna system includes only one of these features. For example, in some implementations, a reconfigurable, radome-integrated PRS as described in reference to FIG. 4 can be controlled by the control system 450 to perform beam-steering even in the absence of dome-shaped parasitic layers (e.g., in conjunction with non-dome-shaped parasitic layers or in conjunction with a traditional phased array under the radome). As another example, in some implementations, dome-shaped parasitic layers as described in reference to FIGS. 2-4 (e.g., with a single antenna or with an antenna array) can be controlled by the control system 450 to perform beam-steering even in the absence of a reconfigurable PRS (e.g., in conjunction with a radome-integrated non-reconfigurable PRS as shown in FIGS. 2 and 3A-3B, or without a radome-integrated PRS).

The radomes described herein with integrated PRS (e.g., reconfigurable or non-reconfigurable PRS) can provide improved beam gain and directivity compared to radomes that lack a PRS. Although radomes, in general, may provide benefits in the absence of an integrated PRS as described herein, high-performance radomes tend to be expensive, such that lower-performance radomes may be used to reduce costs. This can result in decreased gains. With the inclusion of an integrated PRS, the radomes described herein become multifunctional elements that act as antenna superstrates, providing improved gain (e.g., 7 dB more gain in some implementations). Accordingly, with this added benefit, the cost of a high-performance radome can be justified by corresponding gain improvements, and overall system quality can be improved.

In combination, the individual and joint optimization of dome-shaped parasitic layers and radome-integrated PRS can exhibit highly effective performance, for example, because the optimal distances between these layers and the driven antenna are different depending on the field of view.

In some implementations, the dome-shaped parasitic layers and/or the radome-integrated PRS described herein can be fabricated in an additively manufactured electronics (AME) process. For example, a 3D printing process can be used to form the dome-shaped substrate/radome, the pixels, and the adjustable coupling devices, e.g., in a unified process in which both metal layer(s) (for the pixels and adjustable coupling devices) and polymer (for the dome-shaped substrate/radome) are provided additively. The fabrication can include microfabrication processes such as chemical vapor deposition (CVD).

Various implementations of the systems and techniques described here, such as the control system 450 and elements thereof, can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable processing system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” or “computer-readable medium” refer to any computer program product, apparatus and/or device (e.g., magnetic discs, optical disks, memory, Programmable Logic Devices (PLDs)) used to provide machine instructions and/or data to one or more programmable processors, including a machine-readable medium that receives machine instructions.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by the data processing apparatus, cause the apparatus to perform the operations or actions.

Although a few implementations have been described in detail above, other modifications are possible. Logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. An apparatus comprising:
one or more antennas;
control circuitry coupled to the one or more antennas, the control circuitry configured to drive the antennas to emit radiation;
a radome under which the one or more antennas are disposed; and
a partially reflective surface (PRS) in or on the radome, the PRS configured to enhance a gain of emission of the radiation by the one or more antennas.

2. The apparatus of claim 1, wherein the PRS comprises an array of metal portions.

3. The apparatus of claim 1, wherein the PRS is embedded within the radome.

4. The apparatus of claim 1, wherein the PRS is dome-shaped to correspond to a shape of the radome.

5. The apparatus of claim 4, wherein the PRS has a spherical cap shape.

6. The apparatus of claim 1, wherein the PRS comprises:
a plurality of controllable components that are controllable to perform phase-shifting on the radiation emitted by the one or more antennas; and
a plurality of control inputs of the plurality of controllable components,
wherein the control circuitry is configured to deliver control signals to the plurality of control inputs to adjust the phase-shifting.

7. The apparatus of claim 6, wherein the control circuitry is configured to adjust the phase-shifting to cause the radiation to have an intensity peak in a target direction.

8. The apparatus of claim 6, wherein the control circuitry is configured to adjust the phase-shifting to cause the radiation to have an intensity minimum in a target direction.

9. The apparatus of claim 6, wherein a first controllable component of the plurality of controllable components comprises an adjustable coupling device.

10. The apparatus of claim 9, wherein the adjustable coupling device comprises a varactor.

11. A method, comprising:
driving one or more antennas to emit radiation, wherein the one or more antennas are disposed under a radome; and
controlling phase-shifting by a partially reflective surface (PRS) in or on the radome, to cause the radiation to have an intensity peak in a target direction.

12. An apparatus, comprising:
an antenna;
a drive input of the antenna;
a dome-shaped parasitic layer under which the antenna is disposed, the dome-shaped parasitic layer controllable to perform phase-shifting on radiation emitted by the antenna;
one or more control inputs of the dome-shaped parasitic layer; and
control circuitry having outputs coupled to the drive input and the one or more control inputs, the control circuitry configured to:
deliver drive signals to the drive input to drive the antenna to emit the radiation; and
deliver control signals to the control inputs of the dome-shaped parasitic layer to adjust the phase-shifting by the dome-shaped parasitic layer.

13. The apparatus of claim 12, wherein the dome-shaped parasitic layer has a spherical cap shape.

14. The apparatus of claim 12, wherein the control signals are configured to adjust the phase-shifting to cause the radiation to have an intensity peak in a target direction.

15. The apparatus of claim 12, wherein the control signals are configured to adjust the phase-shifting to cause the radiation to have an intensity minimum in a target direction.

16. The apparatus of claim 12, wherein the dome-shaped parasitic layer comprises an adjustable coupling device.

17. The apparatus of claim 16, wherein the adjustable coupling device comprises a varactor.

18. The apparatus of claim 12, wherein the dome-shaped parasitic layer comprises a plurality of portions of metal coupled to one another.

19. The apparatus of claim 18, wherein the plurality of portions of metal are arranged to receive the control signals.

20. The apparatus of claim 12, comprising a dome-shaped substrate under which the antenna is disposed,
wherein the dome-shaped parasitic layer is disposed on a surface of the dome-shaped substrate or in the dome-shaped substrate.

21. The apparatus of claim 20, wherein the dome-shaped substrate comprises a polymer.

22. The apparatus of claim 12, comprising a radome under which the antenna and the dome-shaped parasitic layer are disposed.

23. The apparatus of claim 12, wherein the antenna, the drive input, the dome-shaped parasitic layer, and the one or more control inputs are included in a first reconfigurable emitter of a plurality of reconfigurable emitters,
wherein each reconfigurable emitter of the plurality of reconfigurable emitters comprises a respective antenna, a respective drive input of the respective antenna, a respective dome-shaped parasitic layer, and respective one or more control inputs of the respective dome-shape parasitic layer.

24. The apparatus of claim 23, wherein the control circuitry comprises:
a drive module configured to deliver drive signals to the respective drive inputs of the respective antennas of the plurality of reconfigurable emitters, to control respective amplitudes and phases of respective radiation emitted from the respective antennas of the plurality of reconfigurable emitters;
a phase-shift module configured to deliver control signals to the respective control inputs of the plurality of reconfigurable emitters; and
a joint optimization module configured to jointly determine the drive signals and the control signals to achieve a target objective.

25. The apparatus of claim 24, wherein the target objective comprises that a beam formed by the respective radiation emitted from the respective antennas of the plurality of reconfigurable emitters has a peak in a target direction and has a minimum in a null direction.

26. The apparatus of claim 23, wherein the plurality of reconfigurable emitters are arranged in an array.

27. A method, comprising:
driving one or more antennas to emit radiation, wherein the one or more antennas are disposed under a dome-shaped parasitic layer; and
controlling phase-shifting by the dome-shaped parasitic layer, to cause the radiation to have an intensity peak in a target direction.
